(19) United States
(12) Patent Application Publication
(10) Pub. No.: US 2013/0258491 A1
(43) Pub. Date: Oct. 3, 2013

(54) PROJECTION LENS ASSEMBLY WITH SIX LENSES

(71) Applicants: SHIN-GWO SHIUE, Hukou Township (TW); TZE-YUN SUNG, Hukou Township (TW)

(72) Inventors: SHIN-GWO SHIUE, Hukou Township (TW); TZE-YUN SUNG, Hukou Township (TW)

(21) Appl. No.: 13/434,864

(22) Filed: Mar. 30, 2012

(51) Int. Cl. G02B 3/00

(52) U.S. Cl. 359/649

(57) ABSTRACT

A projection lens assembly with six lenses, suitable for being applied to a pico projector projecting vivid and clear images. The projection lens assembly comprises six lenses, that is, a first lens having a minus focal distance, a second lens having a positive focal distance, a third lens having a minus focal distance, a fourth lens having a positive focal distance, a fifth lens having a positive focal distance and a sixth lens having a positive focal distance arranged in sequence and with spaces therebetween, an aperture stop between the second lens having the positive focal distance and the third lens having the minus focal distance, a reflective liquid-crystal panel behind the sixth lens having the positive focal distance, wherein the front sixth lens having the positive focal distance has a greater area than that of the rear reflective liquid-crystal panel.

### BACKGROUND OF THE DISCLOSURE

a) Field of the Disclosure

The invention relates to a projection lens assembly with six lenses, and more particularly, to a projection lens assembly applied to a pico projector for projecting vivid and clear images.

b) Brief Description of the Related Art

A current desk-top projector provides visual enjoyment of a large screen, but cannot be freely moved due to spatial limitation of a volume and weight thereof and a power supply therefor.

With miniaturization and lightweight of audio and video products like computers and mobile phones, projectors for being easily carried are also developed in a trend of miniaturization. However, products of an early date did not have expected effects because projecting images that are not vivid and clear enough. Accordingly, further improving the products is necessary.

As mentioned above, the miniaturized projector improves the disadvantages of hard mobility of the current desk-top projector. However, with demands of various image magnifications in application to different occasions, the image magnifications can be altered by adjusting a distance between a projection lens and a reflective liquid-crystal panel, but the projected images are often distorted. For example, the projected images individually have areas with different magnifications. This problem is hard to be controlled and should be improved.

### SUMMARY OF THE DISCLOSURE

In order to improve the above disadvantages of the miniaturized projection lens assembly, the invention is directed to an improved projection lens assembly comprising six lenses with minus, positive, minus, positive, positive and positive focal distances arranged in sequence and an aperture stop arranged between the second lens having the positive focal distance and the third lens having the minus focal distance so as to have an adjustable luminous flux and clarity.

In accordance with the present invention, based on the principle of telecentric lens systems, the last lens of the projection lens assembly, that is, the sixth lens having the positive focal distance has a greater area than that of a reflective liquid-crystal panel, that is, a liquid crystal on silicon (LCoS) behind the last lens such that the projection lens assembly has a relatively long back focal distance. Thereby, when a magnifying power is altered by adjusting a distance between the lenses and the reflective liquid-crystal panel, images on the reflective liquid-crystal panel can project onto a screen without any distortion but with a regular proportion.

In one embodiment, the projection lens assembly comprises the six lenses, the aperture stop, a polarizing beam splitter (PBS) and the reflective liquid-crystal panel, wherein the six lenses comprise the first lens having the minus focal distance, the second lens having the positive focal distance, the third lens having the minus focal distance, the fourth lens having the positive focal distance, the fifth lens having the positive focal distance and the sixth lens having the positive focal distance arranged in sequence and with spaces therebetween.

In one embodiment, the projection lens assembly comprises the six lenses, the aperture stop, the polarizing beam splitter (PBS) and the reflective liquid-crystal panel, wherein the aperture stop is arranged between the second lens having the positive focal distance and the third lens having the minus focal distance.

In one embodiment, the projection lens assembly comprises the six lenses, the aperture stop, the polarizing beam splitter (PBS) and the reflective liquid-crystal panel, wherein the polarizing beam splitter is arranged between the sixth lens having the positive focal distance and the reflective liquid-crystal panel, wherein the front sixth lens having the positive focal distance has a greater area than that of the rear reflective liquid-crystal panel.

In one embodiment, the projection lens assembly comprises the six lenses, the aperture stop, the polarizing beam splitter (PBS) and the reflective liquid-crystal panel, wherein the reflective liquid-crystal panel is arranged behind the polarizing beam splitter.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a schematic view of a projection lens assembly with six lenses in accordance with the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

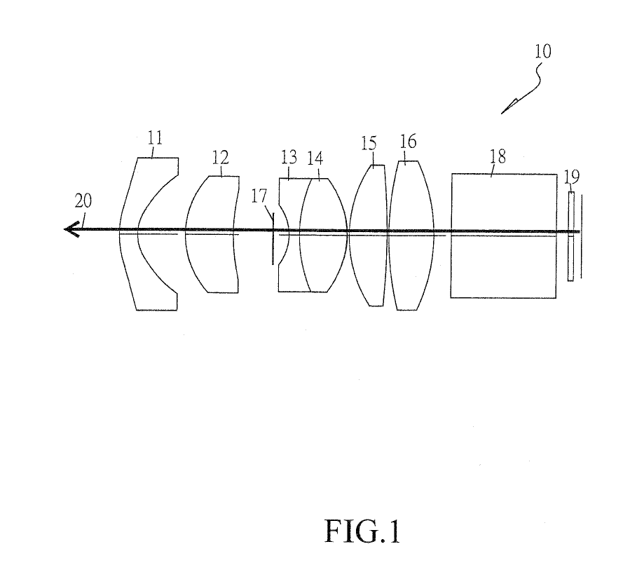

FIG. 1 is a schematic view of a projection lens assembly With six lenses in accordance with the present invention. Referring to FIG. 1, a projection lens assembly 10 comprises six lenses 11, 12, 13, 14, 15 and 16, a aperture stop 17, a polarizing beam splitter 18 (PBS) and 1 reflective liquid-crystal panel 19, that is, a liquid crystal on silicon (LCoS). The six lenses 11-16 comprise a first lens 11 having a minus focal distance, a second lens 12 having a positive focal distance, a third lens 13 having a minus focal distance, a fourth lens 14 having a positive focal distance, a fifth lens 15 having a positive focal distance and a sixth lens 16 having a positive focal distance arranged in sequence. The aperture stop 17 is arranged between the second lens 12 having the positive focal distance and the third lens 13 having the minus focal distance such that the projection lens assembly has an adjustable luminous flux and clarity and an improved vividness. The polarizing beam splitter 18 is arranged between the sixth lens 16 having the positive focal distance and the reflective liquid-crystal panel 19 so as to have a horizontal polarized light pass therethrough but to have a vertical polarized light reflect. The polarizing beam splitter 18 receives a polarized light (not shown) coming from a lower side thereof and along a vertical optical path, and then reflects the polarized light to the rear reflective liquid-crystal panel 19 such that an optical signal for images reflected from the reflective liquid-crystal panel 19 can pass through the polarizing beam splitter 18 and project onto a screen along a projection optical path 20.

Referring to FIG. 1, the polarizing beam splitter 18 is arranged between the sixth lens 16 having the positive focal distance and the reflective liquid-crystal panel 19, and this arrangement has functions as mentioned above, wherein the sixth lens 16 having the positive focal distance has a greater area than that of the reflective liquid-crystal panel 19 based on the principle of telecentric lens systems. Thereby, the projection lens assembly 10 has a relatively long back focal distance. When a magnifying power is altered by adjusting a distance between projection lenses, that is, the lenses 11-16 and the reflective liquid-crystal panel 19, images on the reflective liquid-crystal panel 19 can project on a screen without any distortion but with a regular proportion.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A projection lens assembly comprising:
six lenses comprising a first lens having a minus focal distance, a second lens having a positive focal distance, a third lens having a minus focal distance, a fourth lens having a positive focal distance, a fifth lens having a positive focal distance and a sixth lens having a positive focal distance arranged in sequence and with spaces therebetween;
an aperture stop between the second lens having the positive focal distance and the third lens having the minus focal distance;
a reflective liquid-crystal panel behind the sixth lens having the positive focal distance, wherein the front sixth lens having the positive focal distance has a greater area than that of the rear reflective liquid-crystal panel; and
a polarizing beam splitter between the sixth lens having the positive focal distance and the reflective liquid-crystal panel, wherein the reflective liquid-crystal panel is behind the polarizing beam splitter.
